(19) United States
(12) Patent Application Publication
(10) Pub. No.: US 2018/0131488 A1
(43) Pub. Date: May 10, 2018

(54) METHOD FOR TRANSMITTING AND RECEIVING REFERENCE SIGNAL

(71) Applicant: ELECTRONICS AND TELECOMMUNICATIONS RESEARCH INSTITUTE, Daejeon (KR)

(72) Inventors: Gosan NOH, Daejeon (KR); Il Gyu KIM, Chungcheongbuk-do (KR); Bing HUI, Daejeon (KR)

(21) Appl. No.: 15/798,833

(22) Filed: Oct. 31, 2017

(30) Foreign Application Priority Data
Nov. 4, 2016 (KR) 10-2016-0146743
Sep. 11, 2017 (KR) 10-2017-0115975
Oct. 30, 2017 (KR) 10-2017-0142688

(51) Int. Cl. H04L 5/00; H04W 72/04

(52) U.S. Cl. CPC H04L 5/0051; H04L 25/0202; H04W 72/0446

(57) ABSTRACT

A method of transmitting reference signals is provided by a transmitting apparatus in a wireless communication system. The transmitting apparatus transmits a first reference signal in a first time region of a resource block included in transmission duration. The transmitting apparatus transmits second reference signals scattered on two or more subcarriers in a second time region of the resource block. The second time region follows the first time domain and includes a plurality of symbols.

### CROSS-REFERENCE TO RELATED APPLICATIONS

This application claims priority to and the benefit of Korean Patent Applications Nos. 10-2016-0146743, 10-2017-0115975, and 10-2017-0142688, filed in the Korean Intellectual Property Office on Nov. 4, 2016, Sep. 11, 2017, and Oct. 30, 2017, respectively, the entire contents of which are incorporated herein by reference.

### BACKGROUND

### 1. Field of the Invention

The present invention generally relates to a reference signal transmitting method and a reference signal receiving method.

### 2. Description of Related Art

A multicarrier-based wireless communication system transmits an information signal to be transmitted through an entire frequency band on a plurality of subcarriers so that the delay spread in a time domain and the frequency selective fading in a frequency domain can be overcome. Accordingly, high-speed broadband transmission in a wireless environment is possible.

An orthogonal frequency-division multiplexing (OFDM) transmission scheme is one example of multicarrier-based wireless transmission schemes. In the OFDM, the subcarriers maintain orthogonality in the frequency domain so that the information signal can be transmitted without inter-carrier interference (ICI).

It is required to know channel information through channel estimation in order to perform coherent detection of the received OFDM signal. At this time, a reference signal (RS) composed of a known signal sequence can be used on a part of time-frequency resources of the OFDM signal. The reference signals may be classified into a cell-specific RS (CRS), a user-specific RS, a demodulation RS (DMRS), and a channel state information reference signal (CSI-RS).

Besides the channel estimation, the reference signal may be used, for example, for phase tracking, time/frequency tracking, and radio link monitoring. The phase tracking is used to estimate a phase noise occurring in an oscillator inside a transceiver. An oscillator output signal should be resonant only at a specific frequency, but an oscillation frequency spreads to an adjacent frequency region due to the limitations of the device characteristics such that a phase component of the oscillation output signal can jitter. This phenomenon is called the phase noise. The phase noise is more likely to occur in an oscillator for a high frequency such as a millimeter-wave. Therefore, there is a need for consideration of the phase noise in a millimeter-wave based communication system.

The phase noise has two kinds of effects on the received OFDM signal. The first is a common phase error (CPE) that equally rotates phases of all subcarriers in the OFDM signal. If the phase rotation value is known, the effect of the CPE can be compensated by rotating the phase in an opposite direction again. The second is an ICI component that causes interference between subcarriers.

For fast demodulation in OFDM signal demodulation, a channel estimation reference signal may be loaded in front of a resource block. In this case, the channel estimation is first performed to acquire the channel information and then the channel information can be used in data demodulation, so that a demodulation delay can be minimized. This reference signal can be used to estimate a phase rotation value for CPE compensation. In this case, the phase error cannot be estimated for each symbol, and therefore the existing estimation value is used. However, because correlation of phase error values between adjacent OFDM symbols is low, the estimation error becomes large and the phase value correction cannot be performed properly.

On the other hand, there are cases where the accurate channel estimation is not guaranteed with only the front-loaded reference signal. For example, since a channel coherence time is short in a terminal with fast mobility, the accurate channel estimation cannot be guaranteed only with the front-loaded reference signal. Therefore, it is necessary to design a reference signal in consideration of the phase error estimation and the efficient operation of the channel estimation for demodulation in the fast mobile environment.

### SUMMARY

An embodiment of the present invention provides a reference signal transmitting method and a reference signal receiving method for estimating a phase error and estimating a channel.

According to an embodiment of the present invention, a method of transmitting reference signals is provided by a transmitting apparatus in a wireless communication system. The method includes transmitting a first reference signal in a first time region of a resource block included in transmission duration, and transmitting second reference signals scattered on two or more subcarriers in a second time region of the resource block. The second time region follows the first time domain and includes a plurality of symbols.

The two or more subcarriers may be distant.

In a symbol in which the second reference signal is located, the second reference signal may be located on only one of the two or more subcarriers.

The plurality of symbols may include a symbol in which no second reference signal is located.

The symbol in which no second reference signal is located may exist between two symbols in which the second reference signals located.

The second reference signals may be located alternately on the two or more subcarriers.

The second reference signals may be located on a first subcarrier of the two or more subcarriers in a predetermined number of first symbol(s) and be located on a second subcarrier of the two or more subcarriers in a predetermined number of second symbol(s) following the first symbol so that the second reference signals are located alternately on the two or more subcarriers.

There may be a third symbol, in which no second reference signal is located, between the first symbol and the second symbol.

The predetermined number may be one or two.

The second reference signals may be used for estimating a phase error and a channel.

The transmission duration may be a subframe or a slot.

The first time region may include a symbol following a control region in the resource block.

The first reference signal may be located on a plurality of continuous subcarriers in the first time domain.

According to another embodiment of the present invention, a method of receiving reference signals is provided by a receiving apparatus in a wireless communication system. The method includes receiving a resource block including a first time region and a second time region following the first time region. A first reference signal is located on a plurality of subcarriers in the first time region, and second reference signals are scattered on two or more subcarriers in a plurality of symbols. The method further includes estimating a channel based on the first reference signal, and estimating a phase error based on the second reference signals.

When estimating the channel, the channel may be estimated based on the second reference signals as well as the first reference signal.

The two or more subcarriers may be distant.

The second reference signals may be located alternately on the two or more subcarriers.

The second reference signals may be located on a first subcarrier of the two or more subcarriers in a predetermined number of first symbols) and be located on a second subcarrier of the two or more subcarriers in a predetermined number of second symbol(s) following the first symbol so that the second reference signals are located alternately on the two or more subcarriers.

There may be a third symbol, in which no second reference signal is located, between the first symbol and the second symbol.

According to yet another embodiment of the present invention, a transmitting apparatus is provided in a wireless communication system. The transmitting apparatus includes a processor and a transmitter. The processor locates a first reference signal in a first time region of a resource block included in transmission duration, and locates second reference signals to be scattered on two or more subcarriers in a second time region of the resource block. The second time region follows the first time domain and includes a plurality of symbols. The transmitter transmits the resource block.

According to an embodiment of the present invention, the phase tracking performance can be equally maintained compared with a case where the additional reference signals are located continuously on a specific subcarrier. Further, the channel estimation performance can be improved when the demodulation channel estimation is performed to support high-speed mobility.

### BRIEF DESCRIPTION OF THE DRAWINGS

FIG. 1 schematically shows a wireless communication system according to an embodiment of the present invention.

FIG. 2 shows a method for locating a reference signal in a wireless communication system according to an embodiment of the present invention.

FIG. 3 is a schematic flowchart of a reference signal transmitting method according to an embodiment of the present invention.

FIG. 4, FIG. 5, FIG. 6, FIG. 7, FIG. 8, FIG. 9, FIG. 10, and FIG. 11 each show a method of locating additional reference signals according to various embodiments of the present invention.

FIG. 12 is a schematic flowchart of a reference signal receiving method according to an embodiment of the present invention.

FIG. 13, FIG. 14, FIG. 15, FIG. 16, FIG. 17, FIG. 18, FIG. 19, FIG. 20, FIG. 21, and FIG. 22 each show a method of locating additional reference signals according to various embodiments of the present invention.

### DETAILED DESCRIPTION OF THE EMBODIMENTS

In the following detailed description, only certain embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the specification, a term “terminal” may designate a user equipment (UE), a mobile station (MS), a mobile terminal (MT), an advanced mobile station (AMS), a high reliability mobile station (HR-MS), a subscriber station (SS), a portable subscriber station (PSS), an access terminal (AT), a machine type communication device (MTC device), and so on, or may include all or some functions thereof.

Further, a term “base station” (BS) may designate a node B, an evolved node B (eNB), a gNB, an advanced base station (ABS), a high reliability base station (HR-BS), an access point (AP), a radio access station (RAS), a base transceiver station (BTS), an mobile multihop relay (MMR) BS, a relay station (RS) functioning as the BS, a relay node (RN) functioning as the BS, an advance relay station (ARS) functioning as the BS a high reliability relay station (HR-RS) functioning as the BS, a small BS [e.g., a femto BS, a home node B (HNB), a home eNB (HeNB), a pico BS, a macro BS, a micro BS], and so on, or may include all or some functions thereof.

A term described in the singular may be interpreted as singular or plural unless an explicit term such as “one” or “single” is used.

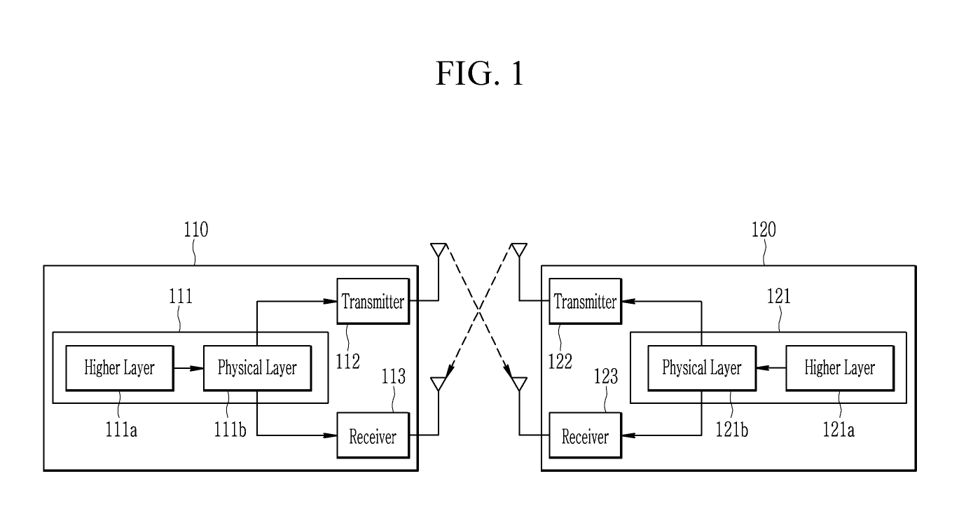

FIG. 1 schematically shows a wireless communication system according to an embodiment of the present invention.

Referring to FIG. 1, a wireless communication system includes a plurality of base stations 110 and a plurality of terminals 120.

The base station 110 transmits a reference signal and downlink data. The terminal 120 receives the reference signal to estimate a channel or a phase error. The terminal 120 transmits a reference signal and uplink data. The base station 120 receives the reference signal to estimate a channel or a phase error.

The base station 110 includes a processor 111 and a transceiver, and the transceiver includes a transmitter 112 and a receiver 113. Each of the processor 111, the transmitter 112, and the receiver 113 may be formed of physical hardware. The transmitter 112 and the receiver 113 may be formed of one piece of hardware (e.g., a chip). All of the processor 111, transmitter 112, and receiver 113 may be formed of one piece of hardware (e.g., a chip).

The processor 111 implements a higher layer 111a and a physical layer 111b, and may execute instructions necessary for operations of the base station 110 and control operations of the transmitter 112 and the receiver 113. The transmitter 112 transmits a signal transferred from the physical layer 111b to the terminal 120 through an antenna, and the receiver 113 receives a signal from the terminal 120 through the antenna and transfers the signal to the physical layer 111b.

Similarly, the terminal 120 includes a processor 121 and a transceiver, and the transceiver includes a transmitter 122 and a receiver 123. Each of the processor 121, the transmitter 122, or the receiver 123 may each be formed of physical hardware. The transmitter 122 and the receiver 123 may be formed of one piece of hardware (e.g., a chip). All of the processor 121, the transmitter 122, and the receiver 123 may be formed of one piece of hardware (e.g., a chip).

The processor 121 implements the higher layer 121a and the physical layer 121b, and may execute instructions necessary for operations of the terminal 120 and control operations of the transmitter 122 and the receiver 123. The transmitter 122 transmits a signal transferred from the physical layer 121b to the base station 110 through an antenna, and the receiver 123 receives a signal from the base station 110 through the antenna and transfers the signal to the physical layer 121b. The transmitter 122 and the receiver 123 may exchange signals with other terminals 120.

In some embodiments, the wireless communication system may be applicable to various wireless communication networks. For example, the wireless communication system may be applied to a wireless communication network based on a current radio access technology (RAT) or 5G or next generation wireless communication network. The 3GPP is developing a new RAT-based 5G standard satisfying IMT-2020 requirements, and such a new RAT is called NR (New Radio).

In some embodiments, the wireless communication system may be a multicarrier system that transmits an information signal through a plurality of subcarriers, and may use a transmission technique such as OFDM, windowed-OFDM, filtered-OFDM, or filtered-bank multi-carrier (FBMC), a generalized frequency-division multiplexing (GFDM). Further, the wireless communication system may include a guard period in a time domain, and the guard interval includes, for example, a cyclic prefix, a cyclic postfix, or a null guard period.

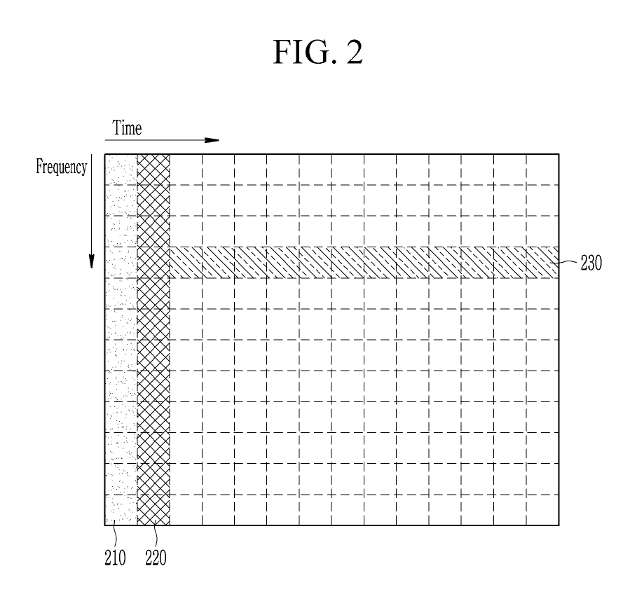

FIG. 2 shows a method for locating a reference signal in a wireless communication system according to an embodiment of the present invention.

Referring to FIG. 2, a reference signal 220 is located just after a control region 210 in a resource block. Additional reference signals are continuously located on one subcarrier in a time domain just after the reference signal 220.

Correlation of phase error values between adjacent OFDM symbols is low. Therefore, if an existing estimation value is used without estimating the phase error for each symbol, an estimation error becomes large and a phase value correction cannot be performed properly. When the additional reference signals 230 are continuously located in the time domain as shown in FIG. 2, the additional reference signals 230 can be used for estimating the phase error.

On the other hand, since the accurate channel estimation cannot be guaranteed only with the reference signal 220, for example, in a terminal with fast mobility, the additional reference signals 230 may be used for channel estimation for data demodulation as well as the phase error estimation. In this case, since the additional reference signals 230 are located on only one subcarrier, channel estimation performance may be deteriorated. Particularly, the additional reference signals 230 have limited ability to accurately estimate a time-selective fading channel that may occur in the terminal environment with fast mobility.

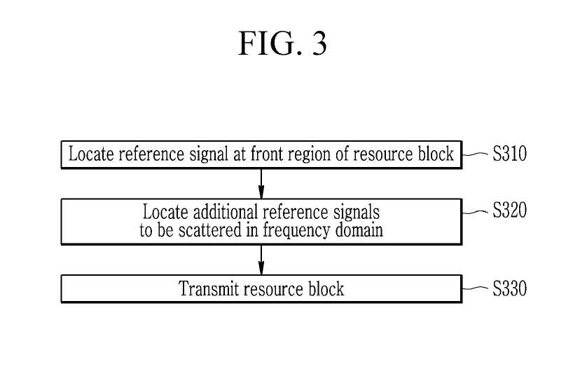

Next, a reference signal transmitting or locating method for improving the channel estimation performance is described with reference to FIG. 3 to FIG. 11. In some embodiments, a reference signal transmitting method may be applied to downlink, uplink, or sidelink of a wireless communication system.

FIG. 3 is a schematic flowchart of a reference signal transmitting method according to an embodiment of the present invention.

Referring to FIG. 3, a transmitting apparatus of a wireless communication system locates a reference signal at a front region of a resource block in transmission duration (S310). Hereinafter, the reference signal located at the front region is referred to as a “front-loaded reference signal.”

In some embodiments, the front-loaded reference signal may be located just after a control region in the transmission duration, and a data region may be located just after the front-loaded reference signal. In some embodiments, the transmission duration may be a slot or a subframe. The resource block may include a plurality of symbols in a time domain and a plurality of subcarriers in a frequency domain.

The transmitting apparatus locates additional reference signals in the data region after the front-loaded reference signal (S320). The transmitting apparatus does not locate the additional reference signals continuously on one subcarrier but locates the additional reference signals to be scattered in the frequency domain on the plurality of symbols in the data region. In some embodiments, the transmitting apparatus may locate the additional reference signals alternately on two or more distant subcarriers. In one embodiment, there may be a symbol in which the additional reference signal is located among the plurality of symbols in the data region. In some embodiments, when the additional reference signals are located alternately on the two or more subcarriers, the additional reference signal may be located on only one subcarrier in each symbol.

Next, the transmitting apparatus transmits the resource block (S330). The resource block may include control information assigned to the control region and data assigned to the data region besides the reference signals.

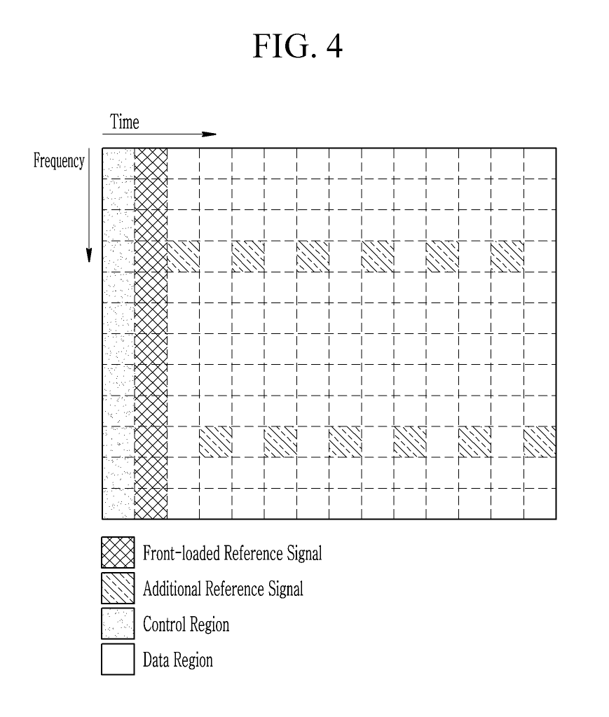

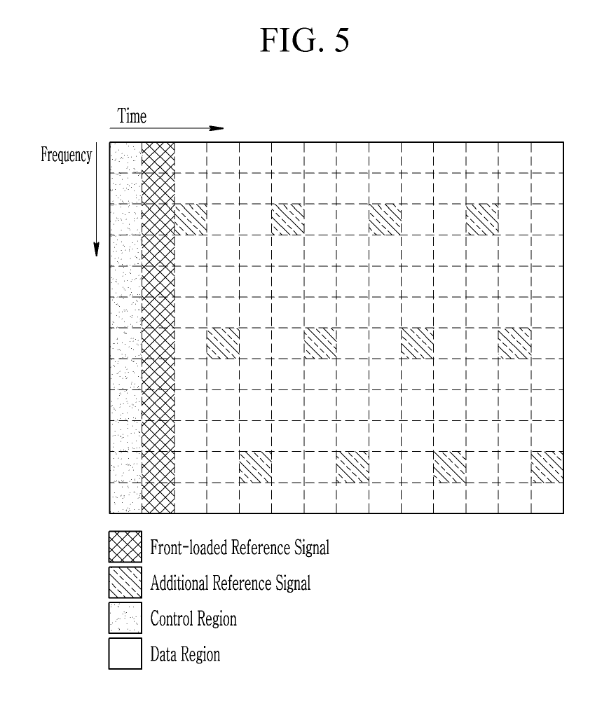

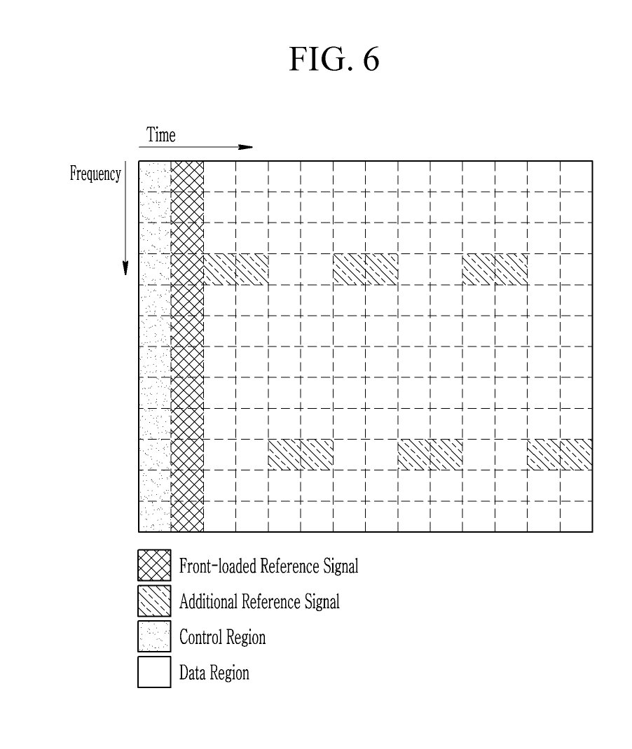

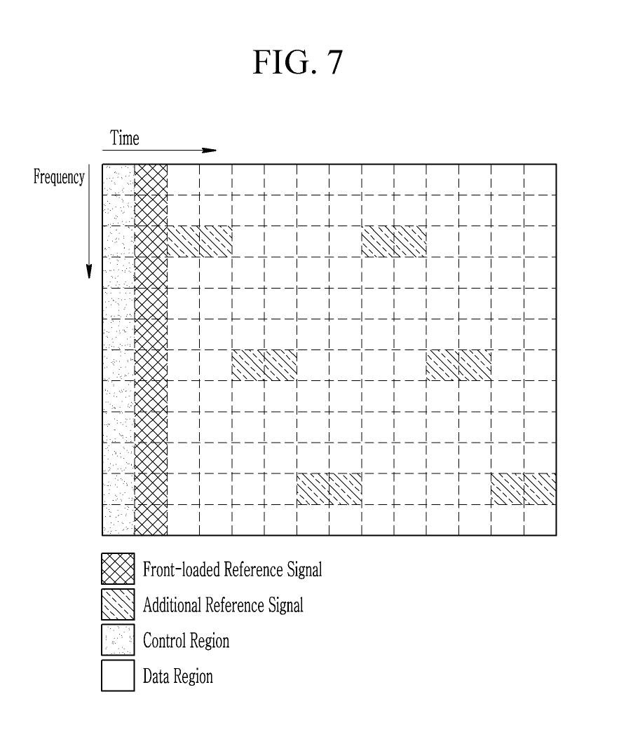

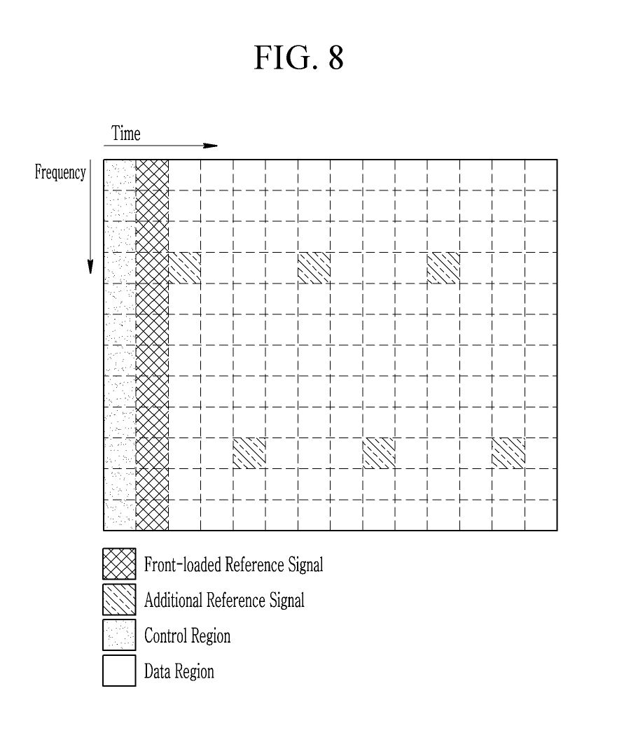

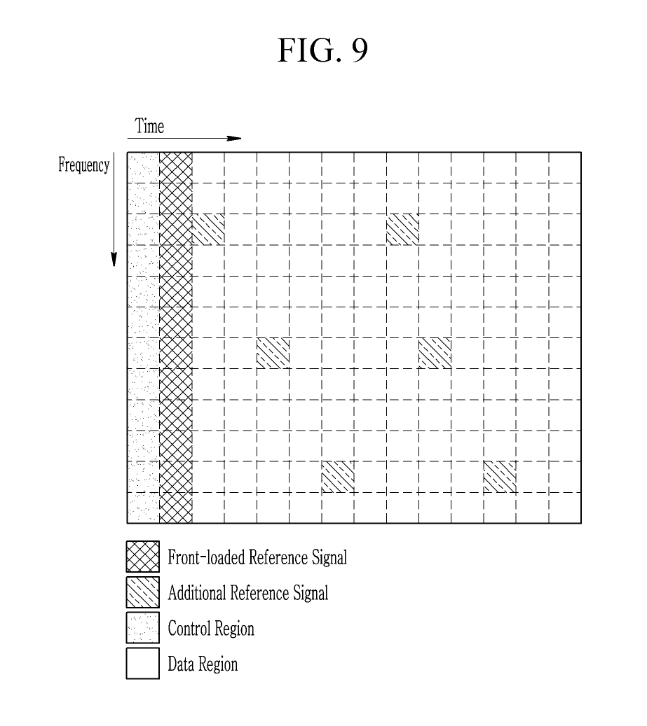

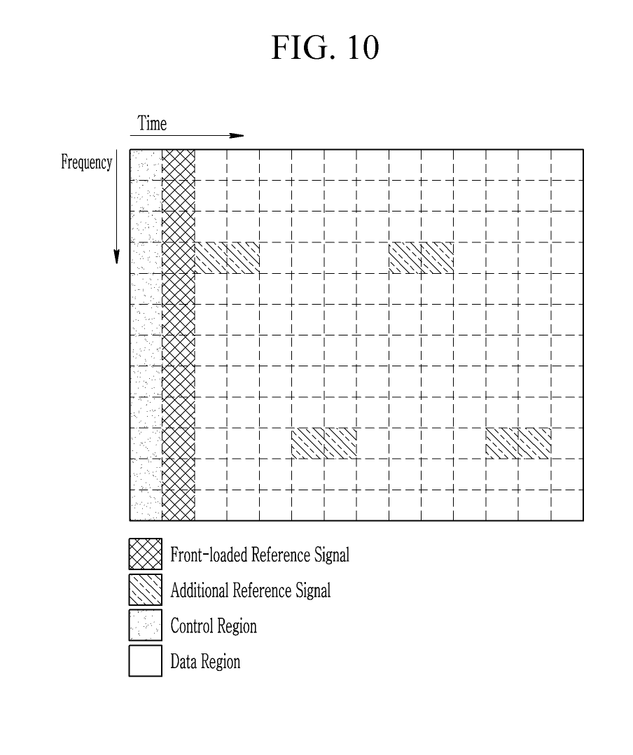

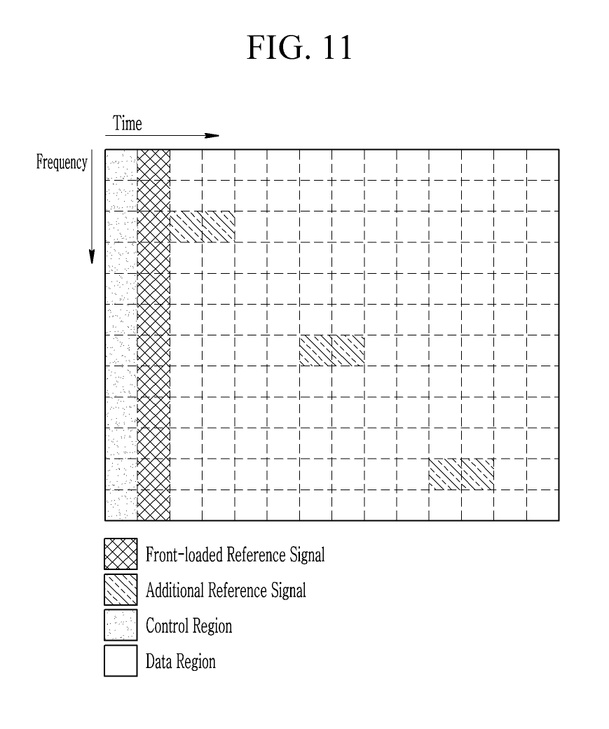

Next, various embodiments for locating additional reference signals are described with reference to FIG. 4 to FIG. 11.

FIG. 4 to FIG. 11 each show a method of locating additional reference signals according to various embodiments of the present invention.

Referring to FIG. 4, in an embodiment, additional reference signals may be located alternately on two subcarriers in a resource block. For example, a transmitting apparatus may locate the additional reference signal on a subcarrier with index j (hereinafter referred to as “subcarrier j”) in a symbol, for example a symbol with index i (hereinafter referred to as “symbol i”) after a front-loaded reference signal, and locate the additional reference signal on a subcarrier kin a symbol (i+1). Further, in subsequent symbols, the transmitting apparatus may locate the additional reference signals alternately on the two subcarriers j and k in the same pattern. In other words, the transmitting apparatus may locate the additional reference signal on the subcarrier j in a symbol (i+2n) and locate the additional reference signal on the subcarrier k in a symbol (i+2n+1). Here, n is an integer greater than or equal to zero.

In some embodiments, the two subcarriers on which the additional reference signals are located may be distant. In other words, a difference between j and k is greater than one.

Even if the additional reference signals are scattered on the two or more subcarriers as described in an embodiment of the present invention, a common phase error (CPE) is the same for all of the subcarriers, and therefore, the phase tracking performance can be equally maintained compared with a case where the additional reference signals are located continuously on a specific subcarrier. On the other hand, since the additional reference signals are scattered in the frequency domain so that an interval between estimable frequencies becomes narrow, the channel estimation performance can be improved when the demodulation channel estimation is performed to support high-speed mobility.

While an example that the additional reference signals are located alternately on subcarriers 3 and 9 has been shown in FIG. 4, indices of subcarriers on which the additional reference signals are located are not limited thereto.

Referring to FIG. 5, in another embodiment, additional reference signals may be located alternately on three or more subcarriers in a resource block

For example, a transmitting apparatus may locate the additional reference signal on a subcarrier with index j in a symbol, for example a symbol i after a front-loaded reference signal, locate the additional reference signal on a subcarrier k in a symbol (i+1), and locate the additional reference signal on a subcarrier l in a symbol (i+2). Further, in subsequent symbols, the transmitting apparatus may locate the additional reference signals alternately on the two subcarriers j, k and l in the same pattern. In other words, the transmitting apparatus may locate the additional reference signal on the subcarrier j in a symbol (i+3n), locate the additional reference signal on the subcarrier k in a symbol (i+3n+1), and locate the additional reference signal on the subcarrier l in a symbol (i+3n+2). Here, n is an integer greater than or equal to zero.

In some embodiments, the three or more subcarriers on which the additional reference signals are located may be distant. In other words, a difference between j and k, a difference between k and l, and a difference between j and l are greater than one.

According to an embodiment described with reference to FIG. 5, since an interval between estimable frequencies is narrower than that in an embodiment described with reference to FIG. 4, the channel estimation accuracy can be further improved.

While an example that the additional reference signals are located alternately on subcarriers 3, 7 and 10 has been shown in FIG. 5, indices of subcarriers on which the additional reference signals are located are not limited thereto.

Referring to FIG. 6 and FIG. 7, in yet another embodiment, when additional reference signals are located to be scattered in the frequency domain, two or more additional reference signals may be just adjacent in the time domain.

As shown in FIG. 6, when additional reference signals are located alternately on two subcarriers in a resource block, two or more additional reference signals may be adjacent. For example, a transmitting apparatus may locate the additional reference signals on a subcarrier j in symbols i and (i+1) after a front-loaded reference signal, and locate the additional reference signals on a subcarrier k in symbols (i+2) and (i+3). Further, in subsequent symbols, the transmitting apparatus may locate the additional reference signals alternately on the two subcarriers j and kin the same pattern. In other words, the transmitting apparatus may locate the additional reference signals on the subcarrier j in a symbol (i+4n) and a symbol (i+4n+1), and locate the additional reference signals on the subcarrier k in a symbol (i+4n+2) and a symbol (i+4n+3). Here, n is an integer greater than or equal to zero.

As shown in FIG. 7, when additional reference signals are located alternately on three or more subcarriers in a resource block, two or more additional reference signals may be adjacent. For example, a transmitting apparatus may locate the additional reference signals on a subcarrier j in symbols i and (i+1) after a front-loaded reference signal, locate the additional reference signals on a subcarrier k in symbols (i+2) and (i+3), and locate the additional reference signals on a subcarrier l in symbols (i+4) and (i+5). Further, in subsequent symbols, the transmitting apparatus may locate the additional reference signals alternately on the three subcarriers j, k and l in the same pattern. In other words, the transmitting apparatus may locate the additional reference signals on the subcarrier j in a symbol (i+6n) and a symbol (i+6n+1), locate the additional reference signals on the subcarrier k in a symbol (i+6n+2) and a symbol (i+6n+3), and locate the additional reference signals on the subcarrier k in a symbol (i+6n+4) and a symbol (i+6n+5). Here, n is an integer greater than or equal to zero.

While it has been shown in FIG. 6 and FIG. 7 that two additional reference signals are just adjacent, three or more additional reference signals may be just adjacent.

While an example that the additional reference signals are located alternately on subcarriers 3 and 9 has been shown in FIG. 5 and an example that the additional reference signals are located alternately on subcarriers 3, 7 and 10 has been shown in FIG. 6, indices of subcarriers on which the additional reference signals are located are not limited thereto.

Referring to FIG. 8, FIG. 9, FIG. 10, and FIG. 11, in still another embodiment, when additional reference signals are located to be scattered in a frequency domain, there may be a symbol in which no additional reference signal is located.

As shown in FIG. 8, when additional reference signals are located alternately on two subcarriers in a resource block, there may be a symbol in which no additional reference signal is located. For example, a transmitting apparatus may locate the additional reference signal on a subcarrier j in a symbol i after a front-loaded reference signal, locate no additional reference signal in a symbol (i+1), locate the additional reference signal on a subcarrier k in a symbol (i+2), and locate no additional reference signal in a symbol (i+3). Further, in subsequent symbols, the transmitting apparatus may locate the additional reference signals alternately on the two subcarriers j and k in the same pattern. In other words, the transmitting apparatus may locate the additional reference signal on the subcarrier j in a symbol (i+4n), locate the additional reference signal on the subcarrier k in a symbol (i+4n+2), and locate no additional reference signal in a symbol (i+4n+1) and a symbol (i+4n+3). Here, n is an integer greater than or equal to zero.

As shown in FIG. 9, when additional reference signals are located alternately on three or more subcarriers in a resource block, there may be a symbol in which no additional reference signal is located. For example, a transmitting apparatus may locate the additional reference signal on a subcarrier j in a symbol i after a front-loaded reference signal, locate no additional reference signal in a symbol (i+1), locate the additional reference signal on a subcarrier k in a symbol (i+2), locate no additional reference signal in a symbol (i+3), locate the additional reference signal on a subcarrier k in a symbol (i+4), and locate no additional reference signal in a symbol (i+5). Further, in subsequent symbols, the transmitting apparatus may locate the additional reference signals alternately on the three subcarriers j, k and l in the same pattern. In other words, the transmitting apparatus may locate the additional reference signal on the subcarrier j in a symbol (i+6n), locate the additional reference signal on the subcarrier k in a symbol (i+6n+2), locate the additional reference signal on the subcarrier l in a symbol (i+6n+4), and locate no additional reference signal in a symbol (i+6n+1), a symbol (i+6n+3) and a symbol (i+6n+5). Here, n is an integer greater than or equal to zero.

As shown in FIG. 10, when additional reference signals are located alternately on two subcarriers in a resource block, two or more additional reference signals may be adjacent and there may be a symbol in which no additional reference signal is located. For example, a transmitting apparatus may locate the additional reference signals on a subcarrier j in a symbol i and a symbol (i+1) after a front-loaded reference signal, locate no additional reference signal in a symbol (i+2), locate the additional reference signal on a subcarrier k in a symbol (i+3) and a symbol (i+4), and locate no additional reference signal in a symbol (i+5). Further, in subsequent symbols, the transmitting apparatus may locate the additional reference signals alternately on the two subcarriers j and k in the same pattern. In other words, the transmitting apparatus may locate the additional reference signal on the subcarrier j in a symbol (i+6n) and a symbol (i+6n+1), locate the additional reference signal on the subcarrier k in a symbol (i+6n+3) and a symbol (i+6n+4), and locate no additional reference signal in a symbol (i+6n+2) and a symbol (i+6n+5). Here, n is an integer greater than or equal to zero.

As shown in FIG. 11, when additional reference signals are located alternately on three or more subcarriers in a resource block, two or more additional reference signals may be adjacent and there may be a symbol in which no additional reference signal is located. For example, a transmitting apparatus may locate the additional reference signal on a subcarrier j in a symbol i and a symbol (i+1) after a front-loaded reference signal, locate no additional reference signal in a symbol (i+2) and a symbol (i+3), locate the additional reference signal on a subcarrier k in a symbol (i+4) and a symbol (i+5), locate no additional reference signal in a symbol (i+6) and a symbol (i+7), locate the additional reference signal on a subcarrier k in a symbol (i+8) and a symbol (i+9), and locate no additional reference signal in a symbol (i+10) and a symbol (i+11).

As described above, the symbol in which no additional reference signal is located is placed in the resource block so that overhead of the reference signals can be reduced.

While an example that the additional reference signals are located alternately on subcarriers 3 and 9 has been shown in FIG. 8 and FIG. 10, and an example that the additional reference signals are located alternately on subcarriers 3, 7 and 10 has been shown in FIG. 9 and FIG. 11, indices of subcarriers on which the additional reference signals are located are not limited thereto.

While examples that the resource block includes 12 subcarriers in the frequency domain and 14 symbols in the time domain have been shown in FIG. 4 to FIG. 11, a size of resource block is not limited thereto. For example, the resource block may include 12 subcarriers in the frequency domain and 7 symbols in the time domain.

In some embodiments, in FIG. 4 to FIG. 11, the number of additional reference signals (i.e., the number of symbols in which the reference signals are located) located in one subcarrier may be equal to the number of additional reference signals located in the other subcarrier.

In some embodiments, a method of locating the additional reference signals in the resource block may be determined by a base station or a network. For example, the base station or the network may select any one among the methods described with reference to FIG. 3 to FIG. 11. In one embodiment, the base station may receive information about a channel or mobility from a terminal or may estimate the information using an uplink signal. In this case, in a case where a channel state is good or a terminal movement speed is slow, a symbol including no additional reference signal may be allocated to the resource block in order to reduce the overhead of the additional reference signals.

In some embodiments, the determined method may be notified to the terminal through resource a control message of the control region in the resource block or a radio resource control (RRC) message.

In some embodiments, a method of locating the additional reference signals may be changed. In one embodiment, the method may be changed dynamically or semi-statically.

In some embodiments, subcarrier spacing in the resource block may be 2ⁿ*15 kHz. For example, the subcarrier spacing may be selected from a set of {15 kHz, 30 kHz, 60 kHz, 120 kHz, 240 kHz, 480 kHz}.

In some embodiments, when a cyclic prefix (CP) is used as a guard interval, either a normal CP or an extended CP longer than the normal CP may be used as a CP length.

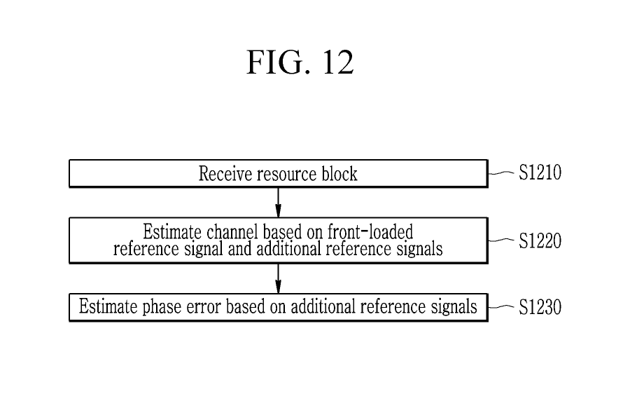

FIG. 12 is a schematic flowchart of a reference signal receiving method according to an embodiment of the present invention.

Referring to FIG. 12, a receiving apparatus of a wireless communication system receives a resource block in transmission duration (S1210). A front-loaded reference signal is located at a front region of the resource block, and additional reference signals are located in the data region after the front-loaded reference signal, as described with reference to FIG. 4 to FIG. 11.

The receiving apparatus estimate a channel based on the front-loaded reference signal (S1220). The estimated channel information may be used for data demodulation. Further, the receiving apparatus estimates a phase error based on the additional reference signals (S1230). The phase error may be used for phase value correction. In some embodiments, the receiving apparatus may use the additional reference signals as well as the front-loaded reference signal when estimating the channel.

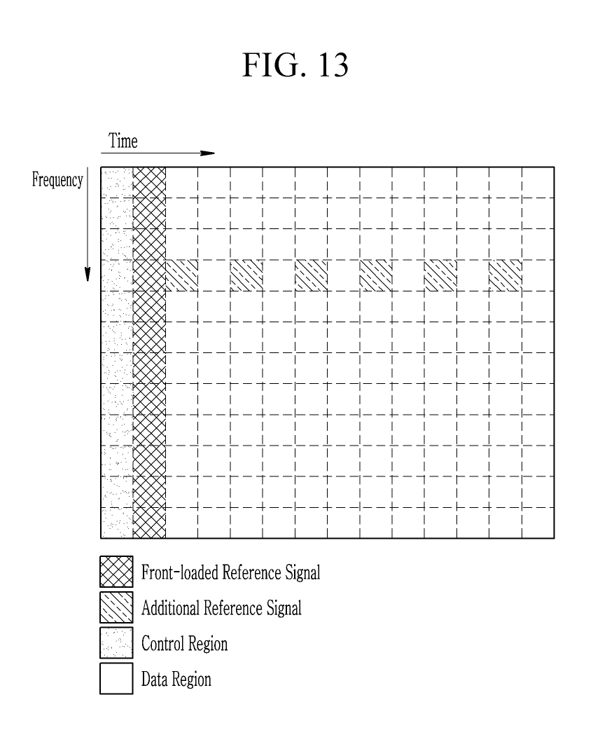

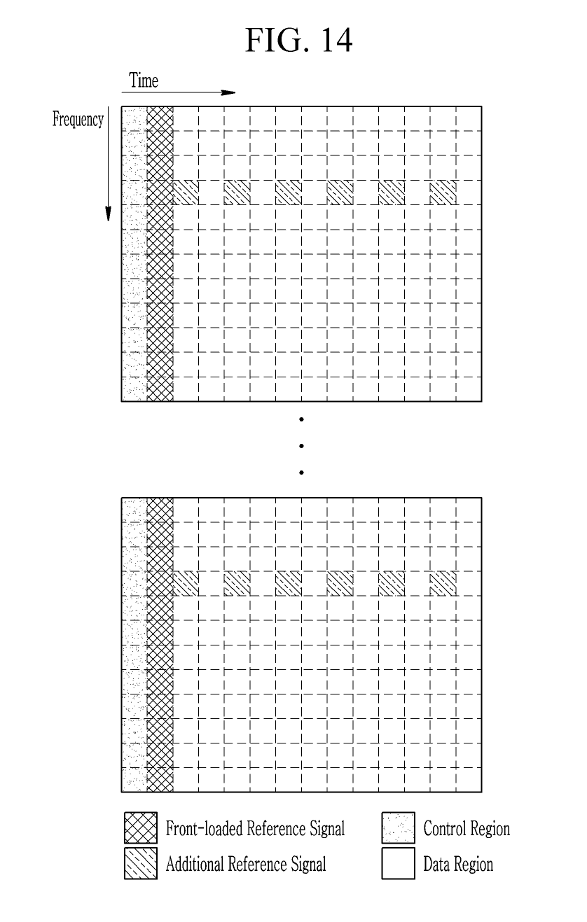

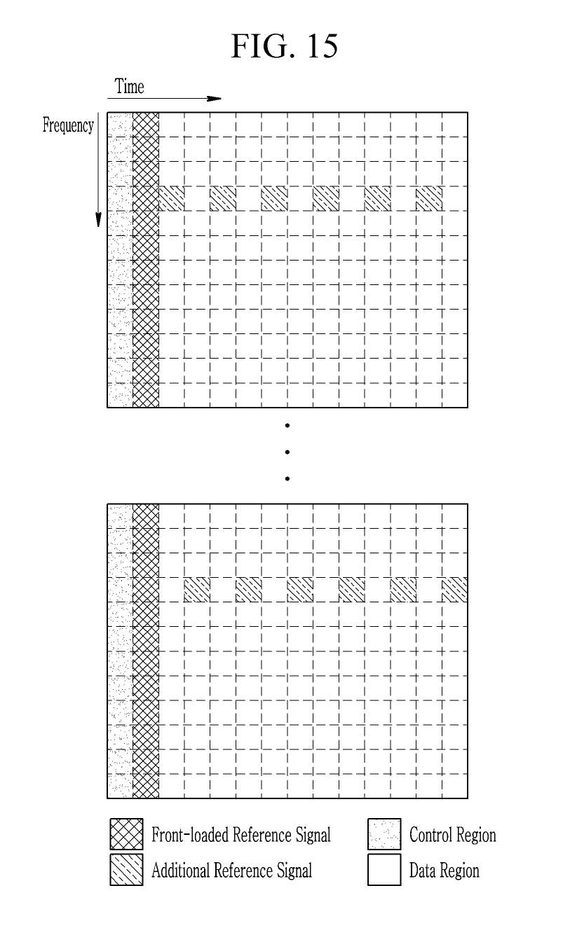

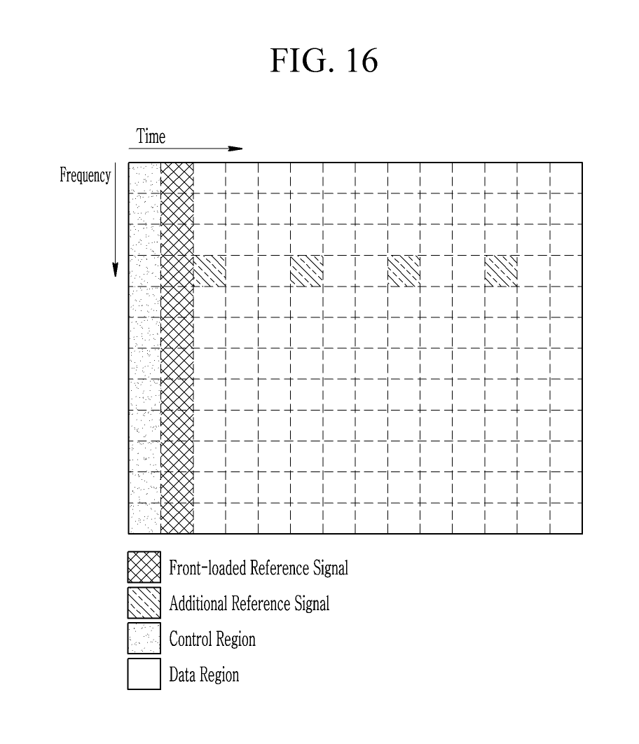

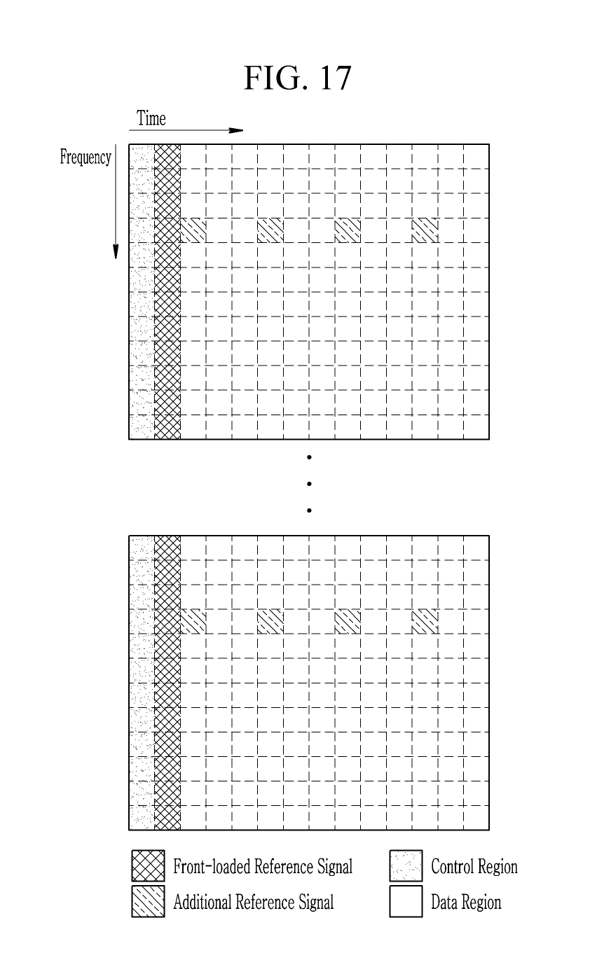

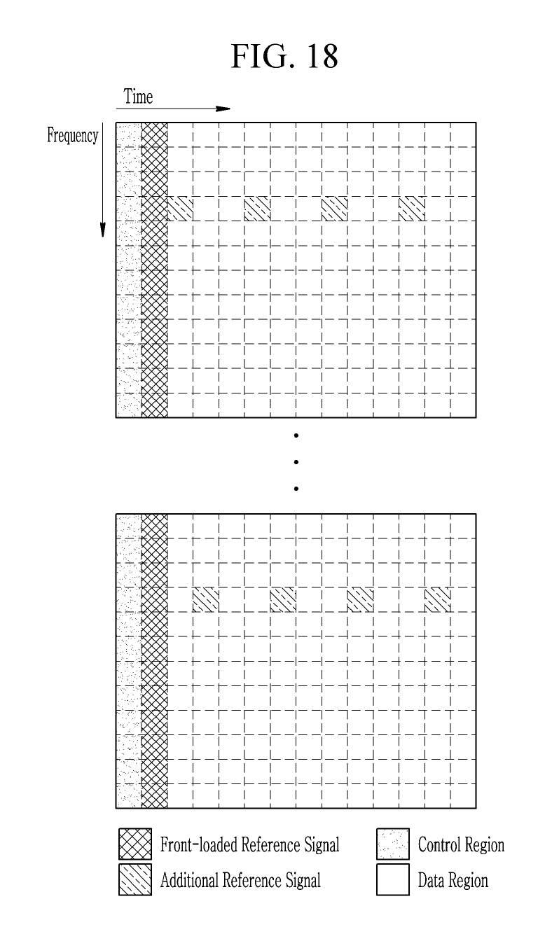

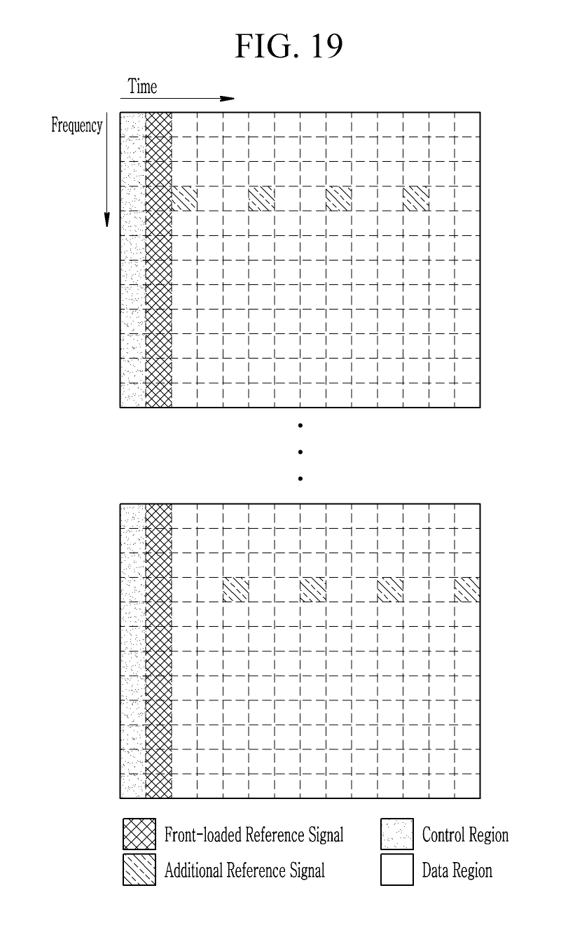

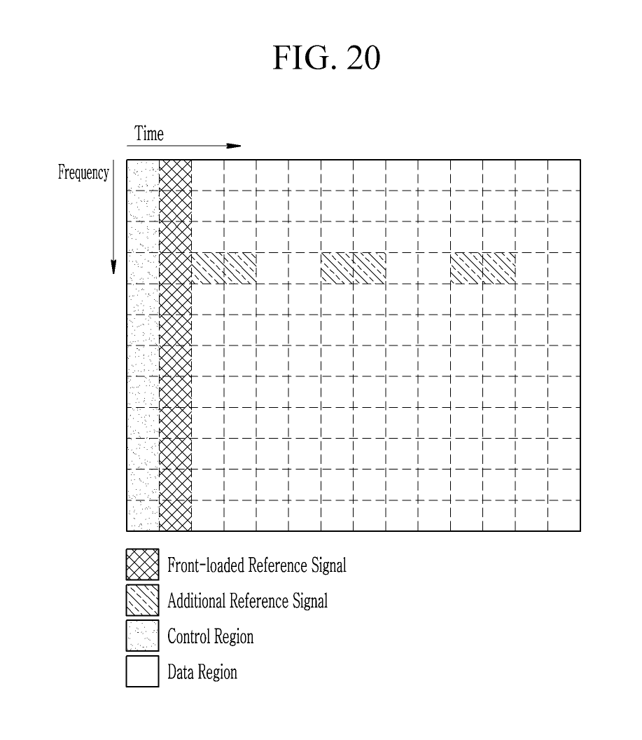

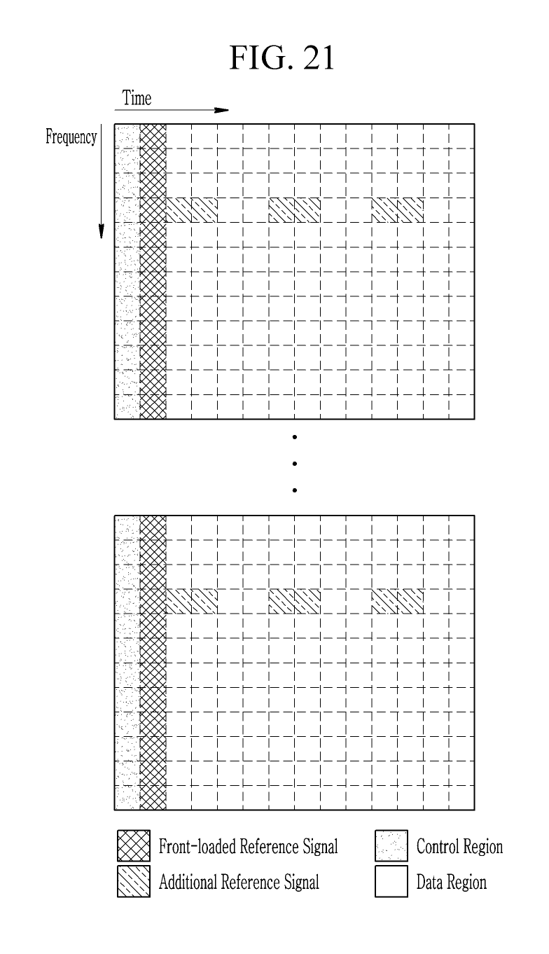

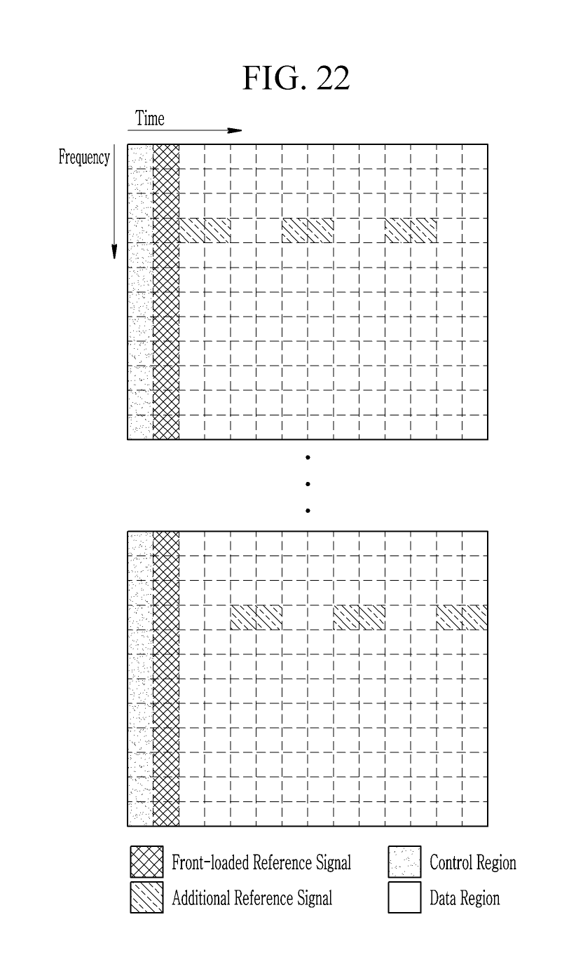

Next, a reference signal transmitting or locating method in a wireless communication system according to another embodiment of the present invention is described with reference to FIG. 13 to FIG. 22.

FIG. 13 to FIG. 22 each show a method of locating additional reference signals according to various embodiments of the present invention.

Referring to FIG. 13 to FIG. 22, when additional reference signals are located on one subcarrier as shown in FIG. 2, there may be a symbol (i.e., a resource element) in which no additional reference signal is located.

As shown in FIG. 13, in one embodiment, when additional reference signals are located on one subcarrier in a resource block, there may be one symbol, in which no additional reference signal is located, between two symbols in which the additional reference signals are located. For example, upon locating the additional reference signals on a subcarrier j, a transmitting apparatus may locate the additional reference signal in a symbol i after a front-loaded reference signal, and locate no additional reference signal in a symbol (i+1). Further, in subsequent symbols, the transmitting apparatus may locate the additional reference signals on the subcarrier j in the same pattern. In other words, the transmitting apparatus may locate the additional reference signal on the subcarrier j in a symbol (i+2n) and locate no additional reference signal in a symbol (i+2n+1). Here, n is an integer greater than or equal to zero.

In some embodiments, the transmitting apparatus may simultaneously transmit a plurality of resource blocks.

In one embodiment, as shown in FIG. 14, additional reference signals may be located on the same symbol positions in a plurality of resource blocks. For example, in the plurality of resource blocks, the additional reference signal may be located on a subcarrier j in a symbol (i+2n), and no additional reference signal may be located in a symbol (i+2n+1).

In another embodiment, as shown in FIG. 15, symbol positions on which additional reference signals are located in one of a plurality of resource blocks may be different from symbol positions on which additional reference signals are located in the other of the resource blocks. For example, in one resource block, the additional reference signal may be located on a subcarrier j in a symbol (i+2n), and no additional reference signal may be located in a symbol (i+2n+1). In the other resource block, the additional reference signal may be located on a subcarrier j in a symbol (i+2n+1), and no additional reference signal may be located in a symbol (i+2n).

While examples that there is one symbol, in which no additional reference signal is located, between two symbols in which the additional reference signals are located have been shown in FIG. 13 to FIG. 15, there may be two or more symbols, in which no additional reference signal is located, between two symbols in which the additional reference signals are located. Next, embodiments in which there are two or more symbols, in which no additional reference signal is located, between two symbols in which the additional reference signals are located are described with reference to FIG. 16 to FIG. 19.

As shown in FIG. 16, in another embodiment, there may be two symbols, in which no additional reference signal is located, between two symbols in which additional reference signals are located. For example, upon locating the additional reference signals on a subcarrier j, a transmitting apparatus may locate the additional reference signal in a symbol i after a front-loaded reference signal, and locate no additional reference signal in a symbol (i+1) and a symbol (i+2). Further, in subsequent symbols, the transmitting apparatus may locate the additional reference signals on the subcarrier j in the same pattern. In other words, the transmitting apparatus may locate the additional reference signal on the subcarrier j in a symbol (i+3n), and locate no additional reference signal in a symbol (i+3n+1) and a symbol (i+3n+2). Here, n is an integer greater than or equal to zero.

While an example that there are two symbols, in which no additional reference signal is located, between two symbols in which the additional reference signals are located has been shown in FIG. 16, there may be three or more symbols, in which no additional reference signal is located, between the two symbols in which the additional reference signals are located.

In some embodiments, the transmitting apparatus may transmit simultaneously a plurality of resource blocks.

In one embodiment, as shown in FIG. 17, additional reference signals may be located on the same symbol positions in a plurality of resource blocks. For example, in the plurality of resource blocks, the additional reference signal may be located on a subcarrier j in a symbol (i+3n), and no additional reference signal may be located in a symbol (i+3n+1) and a symbol (i+3n+2).

In another embodiment, as shown in FIG. 18 and FIG. 19, symbol positions on which additional reference signals are located in one of a plurality of resource blocks may be different from symbol positions on which additional reference signals are located in the other of the resource blocks. For example, as shown in FIG. 18, in one resource block, the additional reference signal may be located on a subcarrier j in a symbol (i+3n), and no additional reference signal may be located in a symbol (i+3n+1) and a symbol (i+3n+2). In the other resource block, the additional reference signal may be located on a subcarrier j in a symbol (i+3n+1), and no additional reference signal may be located in a symbol (i+3n) and a symbol (i+3n+2). In another example, as shown in FIG. 19, in one resource block, the additional reference signal may be located on a subcarrier j in a symbol (i+3n), and no additional reference signal may be located in a symbol (i+3n+1) and a symbol (i+3n+2). In the other resource block, the additional reference signal may be located on a subcarrier j in a symbol (i+3n+2), and no additional reference signal may be located in a symbol (i+3n) and a symbol (i+3n+1). In yet another example, in one resource block, the additional reference signal may be located on a subcarrier j in a symbol (i+3n), and no additional reference signal may be located in a symbol (i+3n+1) and a symbol (i+3n+2). In another resource block, the additional reference signal may be located on a subcarrier j in a symbol (i+3n+2), and no additional reference signal may be located in a symbol (i+3n) and a symbol (i+3n+1). In yet another resource block, the additional reference signal may be located on a subcarrier j in a symbol (i+3n+2), and no additional reference signal may be located in a symbol (i+3n) and a symbol (i+3n+1).

Referring to FIG. 20 to FIG. 22, in yet another embodiment, when additional reference signals are located on one subcarrier so that there is a symbol in which no additional reference signal is located, two or more additional reference signals may be just adjacent in the time domain.

As shown in FIG. 20, when additional reference signals are located on one subcarrier in a resource block, the additional reference signals are located in two adjacent symbols and there may be one or more symbols, in which no additional reference signal is located, between two symbols in which the additional reference signals are located. For example, there may be two symbols, in which no additional reference signal is located, between the two symbols in which the additional reference signals are located. In this case, upon locating the additional reference signals on a subcarrier j, a transmitting apparatus may locate the additional reference signals in a symbol i and a symbol (i+1) after a front-loaded reference signal, and locate no additional reference signal in a symbol (i+2) and a symbol (i+3). Further, in subsequent symbols, the transmitting apparatus may locate the additional reference signals on the subcarrier j in the same pattern. In other words, the transmitting apparatus may locate the additional reference signal on the subcarrier j in a symbol (i+4n) and a symbol (i+4n+1), and locate no additional reference signal in a symbol (i+4n+2) and a symbol (i+4n+3). Here, n is an integer greater than or equal to zero.

While it has been shown in FIG. 20 that the additional reference signals are located in the two adjacent symbols, the additional reference signals may be located in three adjacent symbols. Further, while it has been shown in FIG. 20 that no additional reference signal is located in the two adjacent symbols, no additional reference signal may be located in one symbol or three adjacent symbols.

In some embodiments, the transmitting apparatus may transmit simultaneously a plurality of resource blocks.

In one embodiment, as shown in FIG. 21, additional reference signals may be located on the same symbol positions in a plurality of resource blocks. For example, in the plurality of resource blocks, the additional reference signal may be located on a subcarrier j in a symbol (i+4n) and a symbol (i+4n+1), and no additional reference signal may be located in a symbol (i+4n+2) and a symbol (i+4n+3).

In another embodiment, as shown in FIG. 22, symbol positions on which additional reference signals are located in one of a plurality of resource blocks may be different from symbol positions on which additional reference signals are located in the other of the resource blocks. For example, in one resource block, the additional reference signal may be located on a subcarrier j in a symbol (i+4n) and a symbol (i+4n+1), and no additional reference signal may be located in a symbol (i+4n+2) and a symbol (i+4n+3). In the other resource block, the additional reference signal may be located on a subcarrier j in a symbol (i+4n+2) and a symbol (i+4n+3), and no additional reference signal may be located in a symbol (i+4n) and a symbol (i+4n+1).

As described with reference to FIG. 13 to FIG. 22, the overheads of the reference signals can be reduced by placing symbols in which no additional reference signal is located in the resource block.

While examples that the additional reference signals are located on a subcarrier 3 have been shown in FIG. 13 to FIG. 22, an index of a subcarrier on which the additional reference signals are located is not limited thereto.

While examples that the resource block includes 12 subcarriers in the frequency domain and 14 symbols in the time domain have been shown in FIG. 13 to FIG. 22, a size of resource block is not limited thereto. For example, the resource block may include 12 subcarriers in the frequency domain and 7 symbols in the time domain.

While this invention has been described in connection with what is presently considered to be practical embodiments, it is to be understood that the invention is not limited to the disclosed embodiments, but, on the contrary, is intended to cover various modifications and equivalent arrangements included within the spirit and scope of the appended claims.

What is claimed is:

1. A method of transmitting reference signals by a transmitting apparatus in a wireless communication system, the method comprising:
transmitting a first reference signal in a first time region of a resource block included in transmission duration; and
transmitting second reference signals scattered on two or more subcarriers in a second time region of the resource block, the second time region following the first time domain and including a plurality of symbols.

2. The method of claim 1, wherein the two or more subcarriers are distant.

3. The method of claim 1, wherein in a symbol in which the second reference signal is located, the second reference signal is located on only one of the two or more subcarriers.

4. The method of claim 3, wherein the plurality of symbols includes a symbol in which no second reference signal is located.

5. The method of claim 4, wherein the symbol in which no second reference signal is located exists between two symbols in which the second reference signals located.

6. The method of claim 1, wherein the second reference signals are located alternately on the two or more subcarriers.

7. The method of claim 6, wherein the second reference signals are located on a first subcarrier of the two or more subcarriers in a predetermined number of first symbols) and are located on a second subcarrier of the two or more subcarriers in a predetermined number of second symbols) following the first symbol so that the second reference signals are located alternately on the two or more subcarriers.

8. The method of claim 7, wherein there is a third symbol between the first symbol and the second symbol, no second reference signal being located in the third symbol.

9. The method of claim 7, wherein the predetermined number is one or two.

10. The method of claim 7, wherein the second reference signals are used for estimating a phase error and a channel.

11. The method of claim 1, wherein the transmission duration is a subframe or a slot.

12. The method of claim 1, wherein the first time region includes a symbol following a control region in the resource block.

13. The method of claim 12, wherein the first reference signal is located on a plurality of continuous subcarriers in the first time domain.

14. A method of receiving reference signals by a receiving apparatus in a wireless communication system, the method comprising:
receiving a resource block including a first time region and a second time region following the first time region, a first reference signal being located on a plurality of subcarriers in the first time region and second reference signals being scattered on two or more subcarriers in a plurality of symbols;
estimating a channel based on the first reference signal; and
estimating a phase error based on the second reference signals.

15. The method of claim 14, wherein estimating the channel includes estimating the channel based on the second reference signals as well as the first reference signal.

16. The method of claim 14, wherein the two or more subcarriers are distant.

17. The method of claim 14, wherein the second reference signals are located alternately on the two or more subcarriers.

18. The method of claim 17, wherein the second reference signals are located on a first subcarrier of the two or more subcarriers in a predetermined number of first symbol(s) and are located on a second subcarrier of the two or more subcarriers in a predetermined number of second symbol(s) following the first symbol so that the second reference signals are located alternately on the two or more subcarriers.

19. The method of claim 18, wherein there is a third symbol between the first symbol and the second symbol, no second reference signal being located in the third symbol.

20. A transmitting apparatus in a wireless communication system, comprising:
a processor that locates a first reference signal in a first time region of a resource block included in transmission duration and locates second reference signals to be scattered on two or more subcarriers in a second time region of the resource block, the second time region following the first time domain and including a plurality of symbols; and
transmitting the resource block.
